(19) United States
(12) Patent Application Publication
(10) Pub. No.: US 2024/0239826 A1
(43) Pub. Date: Jul. 18, 2024

(54) METHODS FOR MANUFACTURE OF FLUORINATED PILLAR METAL-ORGANIC FRAMEWORK MATERIALS

(71) Applicants: King Abdullah University of Science and Technology, Thuwal (SA); Saudi Arabian Oil Company, Dhahran (SA)

(72) Inventors: Mohamed EDDAOUDI, Thuwal (SA); Prashant BHATT, Thuwal (SA); Tian JIN, Thuwal (SA)

(21) Appl. No.: 18/152,933

(22) Filed: Jan. 11, 2023

(51) Int. Cl. C07F 15/04; B01J 20/22

(52) U.S. Cl. CPC C07F 15/045; B01J 20/226

(57) ABSTRACT

A method for producing a fluorinated pillar metal-organic framework (MOF) materials is provided that avoids the need for high temperatures, and eliminates or substantially eliminates the need to use hydrofluoric acid. A reaction mixture comprising one or more sources of a metal Mₐ, niobium, fluorine and ligand in a solvent forms the fluorinated pillar MOF materials.

### TECHNICAL FIELD

The present disclosure relates to methods for manufacture of fluorinated pillar metal-organic framework materials.

### DESCRIPTION OF RELATED ART

Fluorinated pillar metal-organic framework (MOF) materials such as KAUST-7 (NbOFFIVE-1-Ni) are a class of material which generally include porous crystalline material assembled from modular molecular building blocks, and provide a wide array of advantageous material properties including high surface area, porosity, and sorption potential.

In typical manufacturing process for NbOFFIVE-1-Ni and other analogous fluorinated MOFs, solvothermal or hydrothermal processes are typically employed requiring high-temperature reaction conditions and use of a significant amount of aqueous hydrofluoric acid, which both hinder large-scale synthesis in an easy and economical manner. For instance, in a typical process. requisite precursors including a Ni²⁺ source and a Nb⁵⁺ source are combined with 5-30 mass percent of hydrofluoric acid at elevated temperatures, for instance 80-200° C., for reaction in a high-temperature, high-pressure vessel.

U.S. Pat. Nos. 10,335,779, 10,850,268 and 11,344,870, which are incorporated by reference herein, disclose MOF materials comprising metal nodes and N-donor organic ligands, and methods for capturing chemical species from fluid compositions comprise contacting a metal organic framework characterized by the formula [M_{g}M_{b}F₆₋ₙ(O/H₂O)w(Ligand)ₓ(solvent)_{y}]_{z}with a fluid composition and capturing one or more chemical species from the fluid composition. U.S. Pat. Nos. 10,328,414, 10,744,482, 11,077,423, which are incorporated by reference herein, disclose MOF materials having high selectivity and stability in the present of gases and vapors including H₂S, H₂O, and CO₂, comprising metal nodes and N-donor organic ligands, and methods of making metal organic frameworks. Embodiments therein MOF compositions comprising a pillar characterized by the formula (M_{b}F₅(O/H2O)), where M_{b} is selected from periodic groups IIIA, IIIB, IVB, VB, VIB, and VIII; and a grid characterized by the formula (Mₐ(ligand)ₓ), where Mₐ is selected from periodic groups IB, IIA, IIB, IIIA, IVA, IVB, VIB, VIIB, and VIII, ligand is a polyfunctional organic ligand, and x is 1 or more; wherein the pillaring of the square grid with the pillars forms the metal-organic framework. U.S. Pat. Nos. 10,328,380 and 10,857,500, which are incorporated by reference herein, disclose MOF materials comprising metal nodes and N-donor organic ligands which have high selectivity and stability in the present of gases and vapors including H₂S, H₂O, and CO₂; methods include capturing one or more of H₂S, H₂O, and CO₂ from fluid compositions, such as natural gas. In these disclosures, the synthesis procedures utilize hydrofluoric acid and are carried out at temperatures between about 80-200° C.

In regard to the above background information, the present disclosure is directed to provide a technical solution for manufacture of MOF materials that avoids or minimizes hindrances related to use of hydrofluoric acid. In addition, the present disclosure is directed to provide a technical solution for manufacture of MOF materials that avoids or minimizes hindrances related to operating at elevated temperatures.

### SUMMARY OF THE DISCLSOURE

A method for producing a fluorinated pillar metal-organic framework (MOF) materials is provided that avoids the need for high temperatures, and eliminates or substantially eliminates the need to use hydrofluoric acid. In certain embodiments the MOF possesses the general formula (MₐNbF₍₆₋ₙ₎Oₙ)(ligand)₂, wherein n=0-4, 1-4, 1-3 1-2 or 1, and wherein Mₐ comprises an element selected from the Periodic Table of the Elements IUPAC Groups 11, 2, 12, 13, 14, 6, 7 or 8-10. In certain embodiments Mₐ comprises nickel and the MOF possesses the formula NiNbOF₅(ligand)₂.

In certain embodiments the method generally comprises: providing a mixture comprising one or more sources of a metal Mₐ, niobium, fluorine and ligand in a solvent, the mixture having no more than about 2 mass percent of hydrofluoric acid; reacting the mixture at a temperature in the range of about 5-60° C. to produce a solid reaction product comprising the (MₐNbF₍₆₋ₙ₎Oₙ)(ligand)₂ MOF; and recovering the (MₐNbF₍₆₋ₙ₎Oₙ)(ligand)₂ MOF solid composition from the mixture.

In certain embodiments the method generally comprises: providing a mixture comprising one or more sources of a metal Mₐ, niobium, fluorine and ligand in a solvent, the mixture having no more than about 2 mass percent of hydrofluoric acid; reacting the mixture at a temperature in the range of about 5-60° C. to produce a solid reaction product comprising the (MₐNbF₍₆₋ₙ₎Oₙ)(ligand)₂ MOF; and recovering the (MₐNbF₍₆₋ₙ₎Oₙ)(ligand)₂ MOF solid composition from the mixture.

In embodiments in which metal Mₐ comprises nickel, the nickel source may be selected from the group consisting of nickel(II) nitrate, hydrated nickel(1I) nitrate, nickel(II) chloride, hydrated nickel(II) chloride, nickel(II) fluoride, hydrated nickel(II) fluoride, nickel(II) oxide, hydrated nickel(II) oxide, and combinations of two or more of the foregoing. The niobium source may be selected from the group consisting of niobium nitrates, hydrated niobium nitrates, niobium chlorides, hydrated niobium chlorides, niobium oxides, hydrated niobium oxides, and combinations of two or more of the foregoing. The ligand source may be one or more compounds selected from the group consisting of pyrazine, pyrimidine, pyridazine, triazine, thiazole, oxazole, pyrrole, imidazole, pyrazole, oxadiazole, thiadiazole, quinoline, benzoxazole, benzimidazole, 1,4-Diazabicyclo[2.2.2]octane, 1,2-bis(4-pyridyl)acetylene, and tautomers thereof. The solvent may comprise water, and/or may comprise one or both of ethanol or methanol.

In certain embodiments, reacting occurs in the presence of 0-1 mass percent hydrofluoric acid. In certain embodiments, reacting occurs in the absence of hydrofluoric acid. In certain embodiments, reacting occurs at a temperature in the range of about 20-25° C. In certain embodiments, reacting occurs at atmospheric or autogenous pressure (from the reaction mixture or from the reaction mixture plus an addition of a gas purge into a reaction vessel prior to heating). In embodiments herein, recovering the MOF solid composition from the mixture may be by separating from a mother liquor, washing and drying.

In certain embodiments, the source of ligand comprises pyrazine (pyz), and the MOF comprises (MₐNbF₍₆₋ₙ₎Oₙ)(pyz)₂ or NiNbOF₅(pyz)₂. In certain embodiments, the fluorine source and the niobium source comprise a niobium fluorocomplex.

In certain embodiments, wherein the Mₐ sources comprises a source of nickel, the niobium fluorocomplex comprises a source of NbF₇, and the ligand precursor comprises pyrazine (pyz), and the MOF comprises NiNbOF₅(pyz)₂. In certain embodiments, the source of NbF, comprises K₂NbF₇.

In certain embodiments, wherein the Mₐ sources comprises a source of nickel, the nickel source comprises a hydrate of nickel(II) nitrate or nickel(II) hydroxide and the ligand source comprises pyrazine (pyz), and the MOF comprises NiNbOF₅(pyz)₂.

In certain embodiments, wherein the Mₐ sources comprises a source of nickel, the nickel source, the fluorine source and the niobium source comprises NiNbOF₅, and the ligand precursor comprises pyrazine (pyz), and the MOF comprises NiNbOF₅(pyz)₂.

In certain embodiments, the MOF comprises NiNbOF₅(pyz)₂, and: either the nickel source comprises Ni(NO₃)₂·6H₂O, and the fluorine and niobium sources comprise K₂NbF₇; the nickel source comprises nickel(II) hydroxide, and the fluorine and niobium sources comprise K₂NbF₇; or the nickel, fluorine and niobium sources comprise NiNbOF₅; and, in combination with one of the above sources, the ligand source comprises pyrazine (pyz), the reaction mixture is formed by: mixing the nickel, fluorine and niobium source(s) in a first quantity of solvent and stirring for a first period of time to form a first mixture; adding pyrazine and a second quantity of solvent water to the first mixture and stirring for a second period of time to form a second mixture, adding a third quantity of water to the second mixture and stirring for a third period of time to form a third mixture as the reaction mixture; and reacting comprises allowing the reaction mixture to stand for a fourth period of time for reaction at the reaction temperature.

In any of the embodiments herein, reacting the reaction mixture may comprise a solvent based synthetic procedure, and/or solvent-drop grinding.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 schematically depicts a method for synthesizing a MOF.

FIG. 2 is a schematic view of an embodiment of a MOF comprising a NiNbF₅O(pyrazine)₂ structure.

FIG. 3 is a schematic view of an embodiment of using MOF for separating a component from gas.

FIG. 4A shows an x-ray diffraction pattern of MOF synthesized in a first example herein compared to a calculated pattern.

FIG. 4B shows an adsorption isotherm using MOF synthesized in the first example.

FIG. 4C shows adsorption kinetics using MOF synthesized in the first example.

FIGS. 5-7 shows x-ray diffraction patterns of MOF synthesized in further examples herein compared to a calculated pattern.

### DETAILED DESCRIPTION OF CERTAIN EMBODIMENTS

Fluorinated pillar metal-organic framework (MOF) materials such as KAUST-7 (NbOFFIVE-1-Ni) have numerous advantageous material properties including high surface area, porosity, and sorption potential. Generally, MOFs comprise a network of nodes and ligands, wherein a node has a connectivity capability at three or more functional sites, and a ligand has a connectivity capability at two functional sites each of which connect to a node. Nodes are typically metal ions or metal containing clusters, and, in some instances, ligands with node connectivity capability at three or more functional sites can also be characterized as nodes. In some instances, ligands can include two functional sites capable of each connecting to a node, and one or more additional functional sites which do not connect to nodes within a particular framework. A molecular building block (MBB) can comprise a metal-based node and an organic ligand which extrapolate to form a coordination network. Such coordination networks have advantageous crystalline and porous characteristics affecting structural integrity and interaction with foreign species (such as gases). The particular combination of nodes and ligands within a framework dictates the framework topology and functionality.

MOFs as synthesized herein comprise one or more MBBs. Generally, a MBB, or a network of MBBs, as provided herein can be represented by the formula:

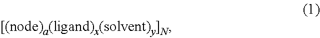

wherein x may be from 1-4, typically 2, y may be from 0-4, and N represents the number of molecular building blocks. Solvent represents a guest molecule occupying pores within the MOF, for example as a result of MOF synthesis, and can be evacuated after synthesis to provide a MOF with unoccupied pores. In certain embodiments, guest molecules can include adsorbed gases, such as CO₂. While guest molecules can impart functionality onto a MOF and are useful during synthesis to occupy pores and impart structure, solvents are not a permanent fixture of the MOF. Accordingly, the value of y can vary down to zero, without changing the definitional framework of the MOF. Therefore, in certain instances MOFs as provided herein are represented without reference to a solvent or guest molecule component by the formula:

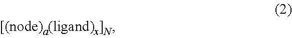

Effective solvents include but are not limited to one or more of H₂O, alcohols including ethanol (EtOH), methanol (MeOH), dimethylformamide (DMF) and diethylfonnamide (DEF) In certain embodiments, solvent includes H₂O.

Certain embodiments herein comprise a porous, uninhabited MOF characterized by the formula (2) wherein node comprises, generally:

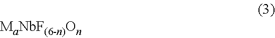

wherein n-0-4, in some embodiments 1. In certain embodiments Mₐ represents a grid constituent and Nb represents a pillar constituent. In certain embodiments Mₐ is Ni as a grid constituent, Nb represents a pillar constituent and n=1. Accordingly the porous, uninhabited MOF, generally having a grid such as one with a square cross section, is represented by the formula:

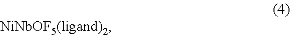

In certain embodiments fluorinated pillar MOFs can be fabricated using a solvent based synthetic procedure involving crystallization reactions on amorphous materials such as sols and gels at low temperatures and pressures. This is in contrast to solvothermal or hydrothermal which occur generally at high temperatures and pressures. Further, hydrofluoric acid is not required as a source of fluorine in the process herein. High-temperature, high-pressure vessels are not required, or is the need for materials that are resistance to the highly corrosive hydrofluoric acid. According to the process herein certain fluorinated pillar MOFs can be fabricated on the scale of hundreds or thousands of kilograms, which is extremely difficult or not economically feasible using conventional synthesis techniques for fluorinated pillar MOFs.

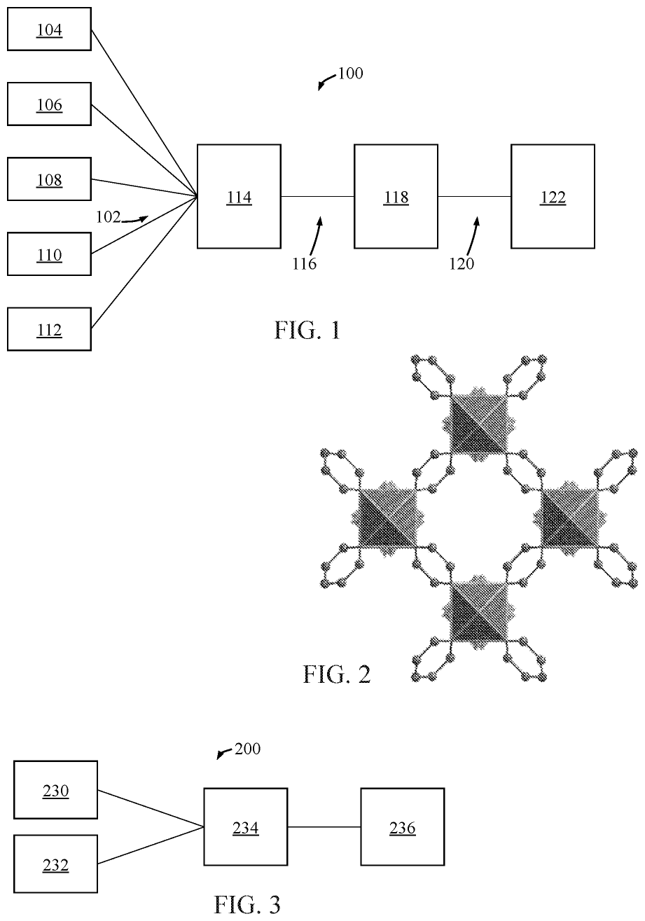

FIG. 1 schematically depicts a method 100 for synthesizing a MOF 122 can include combining 102 reactants. Reactants can include a source 104 of Mₐ, a source 106 of niobium, a source 110 of ligand, a source 108 of fluorine, and a solvent 112 to form a mixture 114.

In certain embodiments, a ligand comprises pyrazine and the stoichiometric amounts provided of Mₐ:Nb:pyrazine are of the ratio 1:1:2. In a synthesis process herein pyrazine may be provided in excess, for instance where the amount is about 2-16 times the stoichiometric equivalent, for example about 2, 3, 5, 10 or 16 times the stoichiometric equivalent. In certain embodiments, Mₐ is Ni, a ligand comprises pyrazine and the stoichiometric amounts provided of Ni:Nb:pyrazine are of the ratio 1:1:2, and in a synthesis process herein pyrazine may be provided in excess, for instance where the amount is about 2-16 times the stoichiometric equivalent, for example about 2, 3, 5, 10 or 16 times the stoichiometric equivalent.

In certain embodiments, very small or trace amounts hydrofluoric acid is included in the reaction mixture 114, for example no more than about 0.001, 0.01, 0.1, 1 or 2 mass percent relative to the total mass of the mixture 114. In certain embodiments there is absence (0 mass percent) of hydrofluoric acid in the reaction mixture 114. For example, hydrofluoric acid may be included in the reaction mixture 114 in an amount of about 0-2, 0-1, 0.001-2, 0.001-1, 0.01-2 or 0.01-1 mass percent relative to the total mass of the mixture 114.

In certain embodiments the source 104 of Mₐ comprises a source of an element selected from the Periodic Table of the Elements IUPAC Groups 11, 2, 12, 13, 14, 6, 7 or 8-10 (CAS Groups IB, IIA. IIB, IIIA, IVA, IVB, VIB, VIIB, or VIII). In certain embodiments the source 104 of Mₐ comprises a source of a cation selected from the group consisting of Cu²⁺, Zn²⁺, Co²⁺, Ni²⁺, Mn²⁺, Zr²⁺, Fe²⁺, Ca²⁺, Ba²⁺. Pb²⁺, Pt²⁺, Pd²⁺, Ru²⁺, Rh²⁺, Cd²⁺, Mg²⁺, Al⁺³, Fe⁺², Fe⁺³, Cr⁺², Cr³⁺, Ru²⁺, Ru³⁺ and Co³. In certain embodiments the source 104 of Mₐ comprises nickel. In certain embodiments the source 104 of Mₐ comprises nickel(II), and can be in the form of nickel(II) nitrate including but not limited to hydrated nickel(II) nitrate; nickel(II) halides including but not limited to hydrated nickel(II) halides, including nickel(II) chloride, nickel(II) fluoride, nickel(II) bromide or hydrated forms thereof; nickel(II) oxide including but not limited to hydrated nickel(II) oxide, or combinations thereof. In certain embodiments the nickel source 104 comprises hydrate of nickel(II) nitrate or nickel(II) hydroxide. In certain embodiments the nickel source 104 comprises Ni(NO₃)₂·6H₂O. In certain embodiments the nickel source 104 comprises nickel(II) hydroxide.

In certain embodiments, source 108 of niobium can be in the form of niobium nitrates, hydrated niobium nitrates, niobium chlorides, hydrated niobium chlorides, niobium oxides, hydrated niobium oxides, and combinations thereof. In certain embodiments the niobium source 108 comprises Nb⁵⁺. In certain embodiments the niobium and fluorine sources 106, 108 are from a single source comprising a niobium fluorocomplex. In certain embodiments the niobium and fluorine sources 106, 108 are from a single source comprising a fluorides or hydrated fluorides of niobium. In certain embodiments the niobium fluorocomplex comprises a source of NbF₇. In certain embodiments, the ligand source 110 comprises pyrazine (pyz).

In certain embodiments, the nickel source 106 comprises a source of Ni²⁺, and the ligand source 110 comprises pyrazine (pyz) to provide a square grid that can be pillared. In certain embodiments, the nickel source 106 comprises a source of Ni²⁺, the ligand source 110 comprises pyrazine (pyz), and the niobium source 108 comprises N⁵⁺, and accordingly a square grid is provided that is pillared with fluorinated pillars (NbOF₅). The square grid forms a three-dimensional structure (NiNbOF₅-(pyz)₂).

The solvent 112 can include one or more of water, ethanol or methanol. In certain embodiments the solvent 112 comprises water. In certain embodiments the solvent 112 comprises ethanol, methanol or a combination thereof.

The MOF synthesis herein comprises linking inorganic chains using appropriate N-donor based linkers to deliberately generate channels along one crystallographic direction. The inorganic chains are built up from the trans-connection between NiN₄F₂ and NbF₄(H₂O)₂ octahedra or between NiN₄F₂ and NbF₅(H₂O) octahedra or between NiN₄F₂ octahedra and NbF₅(O) octahedra. FIG. 2 illustrates a schematic view of one embodiment of a MOF comprising a NiNbF₅O(pyrazine)₂ structure, viewed along the c-axis.

The method 100 further comprises reacting 116 the mixture 114, sufficient to form a reacted mixture 118. Reaction can commence whilst reactants are added. Reacting 116 can include contacting the solvent 112 and the sources 104, 106, 108 and 110 of nickel, niobium, fluorine and ligand, wherein certain sources can be combined as noted herein. Reacting 116 can further comprise stirring or agitating the mixture 114. Optionally, the mixture 114 may be heated to a temperature of no more than about 60° C. Reacting 116 can occur at temperature in the range of about 5-60, 5-50, 5-40, 5-30, 5-25, 10-60, 10-50, 10-40, 10-30, 10-25, 15-25 or 20-25° C. In certain embodiments, reacting 116 can occur at atmospheric or autogenous pressure (from the reaction mixture or from the reaction mixture plus an addition of a gas purge into a reaction vessel prior to heating). In certain embodiments, reacting 116 can occur at a temperature in the range of 20-25° C. at atmospheric or autogenous pressure, and in the absence of hydrofluoric acid or in the presence of no more than 0.1 percent by mass of hydrofluoric acid.

In some embodiments: (a) the nickel source comprises Ni(NO₃)₂·6H₂O, and the fluorine and niobium sources comprise K₂NbF₇; the nickel source comprises nickel(I) hydroxide, and the fluorine and niobium sources comprise K₂NbF₇; or the nickel, fluorine and niobium sources comprise NiNbOF₅; and (b) the ligand source comprises pyrazine (pyz), wherein the MOF comprises NiNbOF₅(pyz)₂. The reaction mixture is formed by: mixing the nickel, fluorine and niobium source(s) (which these can be one or more sources) in a first quantity of solvent and stirring for a first period of time to form a first mixture; adding ligand such as pyrazine and a second quantity of solvent water to the first mixture and stirring for a second period of time to form a second mixture, adding a third quantity of water to the second mixture and stirring for a third period of time to form a third mixture as the reaction mixture; and reacting comprises allowing the reaction mixture to stand for a fourth period of time for reaction at the reaction temperature. For example: the first quantity of water and the second quantity of water are each about 20-40 volume percent of the total water in the reaction mixture; the third quantity of water is about 30-60 volume percent of the total water in the reaction mixture; the first period of time 10-45, 10-30, 15-45 or 15-30 minutes, the second period of time is 2-15, 2-10, 2-8, 3-15, 3-10 or 3-8 minutes, the third period of time is 1-10, 2-10, 3-10, 1-6, 2-6 or 3-6 hours, and the fourth period of time is 4-24, 4-18, 4-12, 6-24, 6-18 or 6-12 hours.

The reacted mixture 118 can be further processed 120 to provide a fabricated MOF 122. Processing 120 can include one or more of filtering the reacted mixture 118, rinsing the reacted mixture 118 with water, removing excess reactants from the reacted mixture 118, and/or drying the reacted mixture 118. In certain embodiments, guest molecules are optionally evacuated from a fabricated MOF 122. Guest molecules can include solvent guest molecules, or derivatives thereof. For example, processing 120 can include separating the solid composition from a mother liquor, washing and drying. In certain embodiments separating is by centrifugation, filtration or both centrifugation and filtration. In certain embodiments washing is by contacting with water and contacting with ethanol. In certain embodiments drying is at a temperature in the range of about 40-80, 50-80, 40-80, 50-70, 55-65° C. or about 60° C.

In certain embodiments, processing 120 may include: separating the NiNbOF₅(ligand)₂ MOF solid composition from a mother liquor by centrifugation, filtration or both centrifugation and filtration; washing the NiNbOF₅(ligand)₂ MOF solid composition by contacting with water one or more times (2-4 or 3 times) and by contacting with ethanol one or more times and dried, wherein during washing the amount of water in each contacting step is approximately equivalent 0.8-3.0 or 0.8-2.0 times the third quantity of water, and drying the NiNbOF₅(ligand)₂ MOF solid composition. The method of making NiNbOF₅(ligand)₂ MOF described herein can occur as a solvent-drop grinding process. For example, a solvent-drop grinding process may comprise: combining the metal precursors and ligand (for example stoichiometric amounts of each, or an excess of ligand) with a quantity of water in a milling vessel; grinding with one or more (for example one) milling balls at a suitable rate for a suitable period of time (for example a predetermined time of about 5-600 minutes). In certain embodiments grinding may occur in the absence of added heat. For example, heat that may be generated during grinding may increase the temperature, but still retain the low temperature operation of the process herein. In certain embodiments metal precursors may be pre-ground (for example with a mortar and pestle) prior to grinding with a milling ball.

In certain embodiments, MOFs synthesized according to the processes described herein are suitable for applications involving CO₂ capture from flue gas, syngas, biogas and landfill gas. In certain embodiments, MOFs synthesized according to the processes described are suitable for applications involving CO₂ removal in confined spaces. Efficient removal of CO₂ at low concentrations is vital for the proper operation of many confined-space systems, such as breathing systems. Confined spaces can include those found in submarines and aerospace craft. For example, in long-term space flight and submarine missions where air resupply opportunities are scarce, CO₂ must be removed from the air and recycled. An average crew member requires approximately 0.84 kg of oxygen and emits approximately 1 kg of carbon dioxide per day. Thus the ability to continuously purify exhaled air to a maximum CO₂ concentration of 2-5% will lead to an optimal recycling and considerable reduction in fresh air supply in remote confined spaces. The shortcomings of existing technologies include a low daily capture capacity, due in part to the long temperature swing adsorption cycling (TSA) mode, which is determined mainly by absorbent reactivation. In case of low CO₂ concentration removal, chemical adsorbents (e.g., amine supported absorbents) are preferred with a heat of adsorption of 70-100 kJ/mol. The heat of adsorption indicates the energy required to clean the material after each adsorption cycle.

In certain embodiments, to fulfil the requisite criteria for high working capacity for CO₂ capture, for example between 80-200 torr (0.1-0.26 bar) CO₂ partial pressure, the target material possesses CO₂ energetics of KAUST-7 (four F interacting with one CO₂) with high CO₂ uptake at desired concentrations.

FIG. 3 illustrates a method 200 for capturing 236 one or more chemical species from a fluid composition 232 via a MOF 230. A method 200 for capturing 236 one or more chemical species from a fluid composition 232 can comprise contacting 234 a metal organic framework 230 MOFs synthesized according to the processes described herein characterized by the formula NiNbOF₅(ligand)₂ with a fluid composition 232. Fluid composition 232 can comprise two or more chemical species. Method 200 can further comprise capturing 236 one or more captured chemical species from the fluid composition 232. In certain embodiments, capturing 236 comprises physical adsorption of the one or more captured chemical species by the metal organic framework 230. In certain embodiments, capturing 236 comprises chemisorption of the one or more captured chemical species by the metal organic framework. Chemisorption can occur by one or more captured chemical species chemically interacting with one or more open metal sites of the metal organic framework 230. In other embodiments, capturing 236 comprises physical adsorption and chemisorption of the one or more captured chemical species by the metal organic framework. Capturing can comprise wholly or partially containing a chemical species within a pore of a MOF. In certain embodiments, capturing 236 consists of chemisorption. In certain embodiments, capturing 236 consists of physical adsorption.

In certain embodiments, the fluid composition 232 can comprise H₂S and one or more of benzene, toluene, xylene, ethylbenzene, naphthalene and styrene. In such embodiments, capturing 236 can comprise capturing one or more of benzene, toluene, xylene, ethylbenzene, naphthalene, and styrene.

In certain embodiments, the fluid composition 232 can comprise breathable air. Breathable air can include atmospheric air, or life-supporting air in a confined space. In a non-limiting example, breathable air can include one or more of oxygen, nitrogen, carbon dioxide, and argon. In such embodiments, capturing 236 can comprise capturing carbon dioxide. In such embodiments, capturing 236 can consist of capturing carbon dioxide. In such embodiments, capturing 236 occurs in a confined space. Capturing 236 can comprise capturing trace amounts of carbon dioxide.

In certain embodiments, the fluid composition 232 can comprise one or more of flue gas, syngas, biogas and landfill gas. In such embodiments, capturing 236 can comprise capturing carbon dioxide. In such embodiments, capturing 236 can consist of capturing carbon dioxide.

### EXAMPLE

Example 1: A quantity of 9.12 g (30 mmol) of K₂NbF₇ and a quantity of 8.72 g (30 mmol) of Ni(NO₃)₂·6H₂O were mixed in 50 ml of water and stirred for 15-30 minutes in a 250 ml plastic container at room temperature (approximately 20° C.). To the resulting solution, a solution of 5.28 g pyrazine (66 mmol) in 50 ml of water was added and stirred for 5 minutes. An additional 100 ml of water was added to reaction mixture and stirred for 3-6 hours at room temperature. The reaction mixture was allowed to stand for 6-12 hours. After the reaction, the solid product was separated from the liquid by centrifugation and washed three times with 100 ml water followed by two times with 100 ml ethanol. The product was then dried at 60° C.

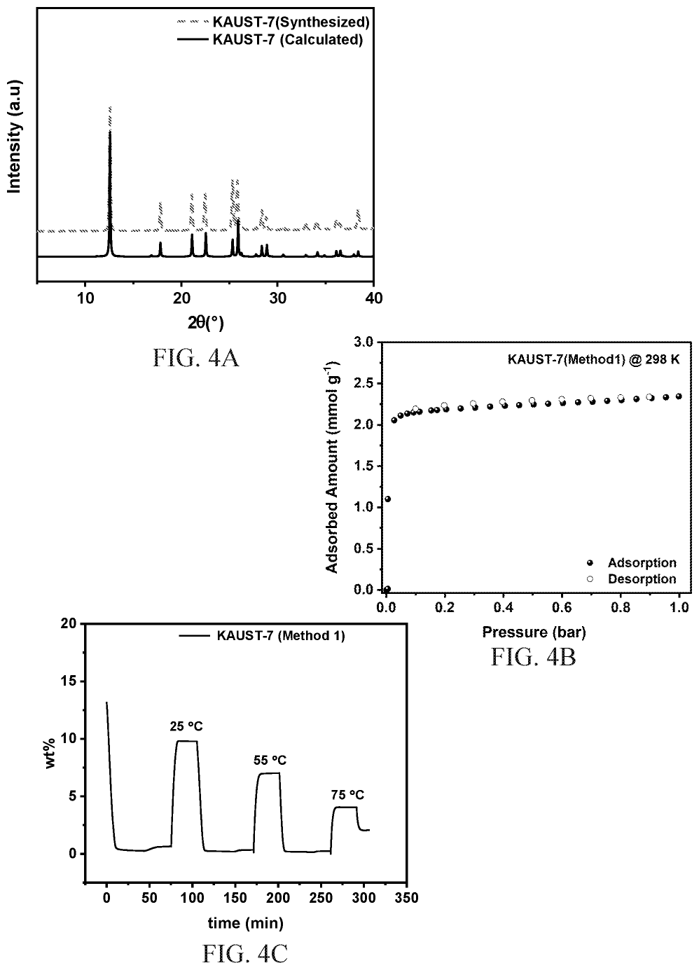

FIG. 4A shows powder X-ray diffraction (PXRD) of the resultant solid NiNbOF₅(pyz)₂ (upper pattern) and calculated single-crystal X-ray diffraction (SCD) structure data of KAUST-7 (NbOFFIVE-1-Ni) (lower pattern), with intensity expressed in arbitrary units (a.u.) plotted against frequency 2θ(°), normalized based on the highest intensity signal and offset for clarity. The structure matches well, and phase purity of the synthesized product is confirmed.

To study the performance of NiNbOF₅(pyz)₂, testing was carried out for CO₂ adsorption using volumetric and gravimetric methods. FIG. 4B depicts a CO₂ adsorption isotherm of adsorbed amount (mmol·g⁻¹) against pressure (bar) at 298 K after 105° C. pretreatment under dynamic vacuum for 8 hr. FIG. 4C depicts CO₂ uptake and adsorption kinetics as weight percent plotted against time (minutes) at 25° C., 55° C. and 75° C., measured using thermogravimetric analysis (TGA) under 1% CO₂ (balance N₂) at 200 cc per minute flow rate using a dry sample mass of 19.66 mg.

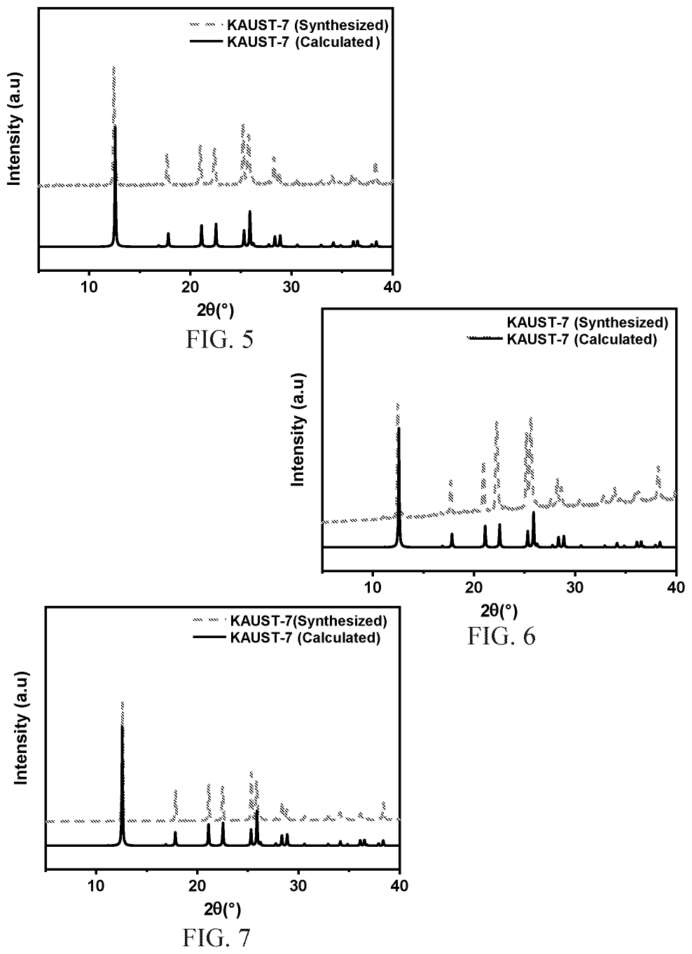

Example 2: A quantity of 152 g (0.5 mol) of K₂NbF₇ and a quantity of 145 g (0.5 mol) of Ni(NO₃)₂·6H₂O were mixed in 100 ml of water and stirred for 15-30 minutes in a 500 ml plastic container at room temperature (approximately 20° C.). To the resulting solution, a solution of 88 g pyrazine (1.1 mol) in 100 ml of water was added and stirred for 5 minutes. An additional 100 ml of water was added to reaction mixture and stirred for 3-6 hours at room temperature. The reaction mixture was allowed to stand for 6-12 hours. After the reaction, the solid product was separated from the liquid and washed three times with 100 ml water followed by two times with 100 ml ethanol. The product was then dried at 60° C. FIG. 5 shows PXRD of the resultant solid NiNbOF₅(pyz)₂ (upper pattern) and calculated single-crystal X-ray diffraction (SCD) structure data of KAUST-7 (NbOFFIVE-1-Ni) (lower pattern); the structures match and phase purity of the synthesized product is confirmed.

Example 3: A quantity of 9.12 g (30 mmol) of K₂NbF₇ and a quantity of 2.78 g (30 mmol) of Ni(OH)₂ were mixed in 50 ml of water and stirred for 15-30 minutes in a 250 ml plastic container at room temperature (approximately 20° C.). To the resulting solution, a solution of 5.28 g pyrazine (66 mmol) in 50 ml of water was added and stirred for 5 minutes. An additional 100 ml of water was added to reaction mixture and stirred for 3-6 hours at room temperature. The reaction mixture was allowed to stand for 6-12 hours. After the reaction, the solid product was separated from the liquid and washed three times with 100 ml water followed by two times with 100 ml ethanol. The product was then dried at 60° C. FIG. 6 shows PXRD of the resultant solid NiNbOF₅(pyz)₂ (upper pattern) and calculated single-crystal X-ray diffraction (SCD) structure data of KAUST-7 (NbOFFIVE-1-Ni) (lower pattern); the structures match and phase purity of the synthesized product is confirmed.

Example 4: A quantity of, 7.87 g (30 mmol) of NiNbOF₅ was dissolved in 50 ml of water and stirred for 15-30 minutes in a 250 ml plastic container at room temperature (approximately 20° C.). To the resulting solution, a solution of 5.28 g pyrazine (66 mmol) in 50 ml of water was added and stirred for 5 minutes. An additional 100 ml of water was added to reaction mixture and stirred for 3-6 hours at room temperature. The reaction mixture was allowed to stand for 6-12 hours. After the reaction, the solid product was separated from the liquid and washed three times with 100 ml water followed by two times with 100 ml ethanol. The product was then dried at 60° C. FIG. 7 shows PXRD of the resultant solid NiNbOF₅(pyz)₂ (upper pattern) and calculated single-crystal X-ray diffraction (SCD) structure data of KAUST-7 (NbOFFIVE-1-Ni) (lower pattern), the structures match and phase purity of the synthesized product is confirmed.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms ““including,” “comprising,” or “having,” “containing,” “involving.” and variations thereof herein, when used in this specification, specify the presence of stated features, integers, steps, operations, elements, and/or components, but do not preclude the presence or addition of one or more other features, integers, steps, operations, elements, components, and/or groups thereof. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A method for producing a (MₐNbF₍₆₋ₙ₎Oₙ)(ligand)₂ metal organic framework (MOF) comprising:
providing a mixture comprising one or more sources of a metal Mₐ, niobium, fluorine and ligand in a solvent, the mixture having no more than about 2 mass percent of hydrofluoric acid;
reacting the mixture at a temperature in the range of about 5-60° C. to produce a solid reaction product comprising the (MₐNbF₍₆₋ₙ₎Oₙ)ligand)₂ MOF; and
recovering the (MₐNbF₍₆₋ₙ₎Oₙ)ligand)₂ MOF solid composition from the mixture, wherein n=0-4, 1-4, 1-3 1-2 or 1, and wherein Mₐ comprises an element selected from the Periodic Table of the Elements IUPAC Groups 11, 2, 12, 13, 14, 6, 7 or 8-10.

2. (canceled)

3. A method for producing a NiNbOF₅(ligand)₂ metal organic framework (MOF) comprising:
providing a mixture comprising one or more sources of nickel, niobium, fluorine and ligand in a solvent, the mixture having no more than about 2 mass percent of hydrofluoric acid;
reacting the mixture at a temperature in the range of about 5-60° C. to produce a solid reaction product comprising the NiNbOF₅(ligand)₂ MOF; and
recovering the NiNbOF₅(ligand)₂ MOF solid composition from the mixture.

4. A method for producing a NiNbOF₅(ligand)₂ metal organic framework (MOF) comprising:
providing a reaction mixture comprising a metal node precursor of a nickel source, a pillar precursor of one or more sources of fluorine and niobium source, a source of ligand and a solvent, the reaction mixture having from 0-2 mass percent hydrofluoric acid;
reacting the reaction mixture at a temperature in the range of about room temperature or in the range of about 5-60° C. to produce a solid reaction product comprising the NiNbOF₅(ligand)₂ MOF; and
recovering a NiNbOF₅(ligand)₂ MOF solid composition from the mixture.

5. The method as in claim 3, wherein the nickel source is selected from the group consisting of nickel(II) nitrate, hydrated nickel(II) nitrate, nickel(II) chloride, hydrated nickel(II) chloride, nickel(II) fluoride, hydrated nickel(II) fluoride, nickel(II) oxide, hydrated nickel(II) oxide, and combinations of two or more of the foregoing.

6. The method as in claim 1, wherein the niobium source is selected from the group consisting of niobium nitrates, hydrated niobium nitrates, niobium chlorides, hydrated niobium chlorides, niobium oxides, hydrated niobium oxides, and combinations of two or more of the foregoing.

7. The method as in claim 1, wherein the ligand source is one or more compounds selected from the group consisting of pyrazine, pyrimidine, pyridazine, triazine, thiazole, oxazole, pyrrole, imidazole, pyrazole, oxadiazole, thiadiazole, quinoline, benzoxazole, benzimidazole, 1,4-Diazabicyclo[2.2.2]octane, 1,2-bis(4-pyridyl)acetylene, and tautomers thereof.

8. The method as in claim 1, wherein the solvent comprises one or more of water, ethanol or methanol.

9. (canceled)

10. The method as in claim 1, wherein reacting occurs in the presence of 0-1 mass percent hydrofluoric acid.

11. The method as in claim 1, wherein reacting occurs in the absence of hydrofluoric acid.

12. The method as in claim 1, wherein reacting occurs at a temperature in the range of about 20-25° C.

13. (canceled)

14. (canceled)

15. The method as in claim 1, wherein the source of ligand comprises pyrazine (pyz), and the MOF comprises (MₐNbF₍₆₋ₙ₎Oₙ)(pyz)₂ or NiNbOF₅(pyz)₂.

16. The method as in claim 1, wherein the fluorine source and the niobium source comprise a niobium fluorocomplex.

17. The method as in claim 16, wherein the Mₐ sources comprises a source of nickel, the niobium fluorocomplex comprises a source of NbF₇, and the ligand precursor comprises pyrazine (pyz), wherein the MOF comprises NiNbOF₅(pyz)₂.

18. The method as in claim 17, wherein the source of NbF₇ comprises K₂NbF₇.

19. The method as in claim 16, wherein the Mₐ sources comprises a source of nickel, wherein the nickel source comprises a hydrate of nickel(II) nitrate or nickel(II) hydroxide and the ligand source comprises pyrazine (pyz), wherein the MOF comprises NiNbOF₅(pyz)₂.

20. The method as in claim 1, wherein the Mₐ sources comprises a source of nickel, and wherein the nickel source, the fluorine source and the niobium source comprises NiNbOF₅, and the ligand precursor comprises pyrazine (pyz), wherein the MOF comprises NiNbOF₅(pyz)₂.

21. The method as in claim 3:
wherein:
the nickel source comprises Ni(NO₃)₂·6H₂O, and the fluorine and niobium sources comprise K₂NbF₇;
the nickel source comprises nickel(II) hydroxide, and the fluorine and niobium sources comprise K₂NbF₇; or
the nickel, fluorine and niobium sources comprise NiNbOF₅; and
the ligand source comprises pyrazine (pyz);
wherein the MOF comprises NiNbOF₅(pyz)₂;
and
wherein:
the reaction mixture is formed by:
mixing the nickel, fluorine and niobium source(s) in a first quantity of solvent and stirring for a first period of time to form a first mixture;
adding pyrazine and a second quantity of solvent water to the first mixture and stirring for a second period of time to form a second mixture;
adding a third quantity of water to the second mixture and stirring for a third period of time to form a third mixture as the reaction mixture;
and
reacting comprises allowing the reaction mixture to stand for a fourth period of time for reaction at the reaction temperature.

23. The method as in claim 1, wherein reacting the reaction mixture comprises a solvent based synthetic procedure.

24. The method as in claim 1, wherein reacting the reaction mixture comprises solvent-drop grinding.
